(19) United States
(12) Patent Application Publication
(10) Pub. No.: US 2014/0372939 A1
(43) Pub. Date: Dec. 18, 2014

(54) SYSTEMS AND METHODS FOR ASSISTING IN SELECTION AND PLACEMENT OF GRAPHICAL OBJECTS IN A GRAPHICAL USER INTERFACE

(71) Applicant: Zamurai Corporation, Los Gatos, CA (US)

(72) Inventors: Michael Parker, Los Gatos, CA (US); E. Patrick Hanavan, III, Winter Springs, FL (US); Jerry Anders, Ojai, CA (US)

(73) Assignee: ZAMURAI CORPORATION, Los Gatos, CA (US)

(21) Appl. No.: 14/307,386

(22) Filed: Jun. 17, 2014

Related U.S. Application Data
(60) Provisional application No. 61/836,099, filed on Jun. 17, 2013.

(51) Int. Cl. G06F 3/0488; G06F 3/0481

(52) U.S. Cl. CPC G06F 3/0488; G06F 3/0481
USPC 715/799

(57) ABSTRACT

Some embodiments detect a first condition for presenting a view window on a touch screen display, detect a first position of a fingertip on the touch screen display, and present the view window on the touch screen display at a second position based on the first position. The view window may provide a first view of graphical content presented under the fingertip on the touch screen display at the first position. The embodiment may detect movement of the fingertip from the first position to a third position, and move the view window accordingly from the second position to a fourth position based on the third position. The embodiment may update the view window to provide a second view of graphical content presented under the fingertip on the touch screen display at the third position. The embodiment may detect a second condition for removing the view window from the touch screen display.

### CROSS-REFERENCE TO RELATED APPLICATIONS

The present application claims priority from U.S. Provisional Patent Application Ser. No. 61/836,099, filed Jun. 17, 2013, entitled “Method and Graphical User Interface for Precision Placement and Selection of Objects for Touch-enabled Devices,” which is incorporated herein by reference.

### BACKGROUND

1. Technical Field

The present invention(s) generally relate to graphical user interfaces (GUIs) and, more particularly, relate to selection or placement of graphical objects through a GUI, such as one provided by a touch-enabled computing device.

2. Description of Related Art

With touch-enabled computing devices, such as tablets, smart phones, and like, the user typically operates the device using one or more their fingertips on a touch sensitive display. Generally, a cursor is not presented on the touch sensitive display and the location of at least one of the fingertips take the place of a cursor on the touch sensitive display. However, unlike use of a mouse and a cursor, which floats above graphical elements (e.g., text, shape, or other graphical objects) presented on a display device, use of fingers and fingertips on a touch sensitive display obscures a user's visibility of graphical elements presented on the touch sensitive display below those fingers and fingertips. This presents a problem when a user attempts to access graphical elements displayed on the touch sensitive display, such as when the user selects, resizes, positions, orients, or connects graphical objects located below the fingers or fingertips.

### SUMMARY

Various embodiments described herein provide for systems and methods that assist in selection or placement of a graphical object through a graphical user interface (GUI), such as one provided by a touch screen display of a computing device.

According to some embodiments, a system or method detects a first condition for presenting a view window on a touch screen display, determines a first position of a fingertip on the touch screen display, and then presents the view window on the touch screen display at a second position based on the first position (e.g., relative to the first position). The view window may be configured to provide a first view of graphical content presented under the fingertip on the touch screen display at the first position (e.g., while the first fingertip remains at the first position). For instance, where a user selects a graphical object presented on the touch screen display, and the user performs the selection using their fingertip, the view window would present a view of the graphical object as it appears on the touch screen display under the user's fingertip. Subsequently, the system or method may detect movement of the fingertip from the first position to a third position (e.g., in association with selecting, moving, orienting, connecting or resizing a graphical object), and move the view window accordingly from the second position to a fourth position based on the third position (e.g., relative to the third position). Additionally, the system or method may update the view window to provide a second view of graphical content presented under the fingertip on the touch screen display at the third position. In this way, as the fingertip moves across a touch screen display (e.g., fingertip is dragged across the touch screen display), the view window can move accordingly and have the view window track the fingertip. Eventually, the system or method may detect a second condition for removing the view window from the touch screen display. The first view, the second view, or both may provide a magnified view of graphical content presented under the fingertip on the touch screen display.

For some embodiments, the graphical content presented at the first position on the touch screen display, or presented at the second position on the touch screen display, comprises one or more graphical objects. The graphical content can include shapes (e.g., circles, quadrilateral, triangles, etc.), text, lines, stencil objects, an image (e.g., imported), or the like. The system or method may determine the second position based on the first position or may determine the fourth position based on the third position. For instance, the second position may be determined according to a predetermined distance from the first position, or the fourth position may be determined according to a predetermined distance from the third position.

Depending on the embodiment, the first condition may comprise the fingertip being positioned within a predetermined distance from a graphical object presented on the touch screen display (e.g., the fingertip being moved within the predetermined distance from the graphical object). The first condition may comprise selection of a graphical object presented on the touch screen display, where the selection is caused by use of the fingertip on the touch screen display. The first condition may be limited to one or more specific types of graphical object (e.g., end point of a line, anchor points, vertex, etc.). The first condition may relate to selecting, moving, orienting, connecting or resizing a first graphical object presented on the touch screen display, where the selection, movement, orientation, or resizing is caused by use of the fingertip on the touch screen display. For some embodiments, the selecting, moving, orienting, connecting or resizing the first graphical object involves two or more fingertips, which may result in the user's hand obscuring the user's view of the first graphical object during the selecting, moving, orienting, connecting or resizing. The first condition may comprise a first graphical object presented on the touch screen display being positioned within a predetermined distance from a second graphical object presented on the touch screen display. The first condition may comprise receiving from a user an instruction to enable the view window (e.g., user instruction through an element of GUI).

Depending on the embodiment, the second condition may comprise the fingertip being positioned outside a predetermined distance from a graphical object presented on the touch screen display (e.g., fingertip is moved away from the graphical object). The second condition may comprise de-selection of a (currently selected) graphical object presented on the touch screen display. The second condition may comprise removal of contact between the fingertip and the touch screen display. The second condition may comprise a first graphical object presented on the touch screen display being positioned outside a predetermined distance from a second graphical object presented on the touch screen display. The second condition comprises receiving from a user an instruction to disable the view window (e.g., user instruction through an element of GUI).

Various embodiments provide for a computer program product comprising computer instruction codes configured to cause the computer system to perform various operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an example environment that may be used with various embodiments.

FIG. 2 is a block diagram illustrating an example client device in accordance with various embodiments.

FIG. 3 is a flowchart illustrating an example method for assisting with graphical objects in accordance with various embodiments.

FIGS. 4A-4C illustrate an example graphical user interface canvas using graphical object assistance in accordance with various embodiments.

FIGS. 5A-5C illustrate an example graphical user interface canvas using graphical object assistance in accordance with various embodiments.

FIGS. 6A-6C illustrate an example graphical user interface canvas using graphical object assistance in accordance with various embodiments.

FIGS. 7A-7C illustrate an example graphical user interface canvas using graphical object assistance in accordance with various embodiments.

FIG. 8 is a block diagram illustrating an exemplary digital device that can be utilized in the implementation of various embodiments.

### DETAILED DESCRIPTION

Various embodiments described herein provide for systems and methods that assist in selection or placement of a graphical object through a graphical user interface (GUI), such as one provided by a touch screen display of a computing device.

Some embodiments provide for a system or method that assists with arranging or connecting a graphical object presented on display device, such as a line, vertex (e.g., elbow), rectangle, circle, text box, image, and the like. The system or method may assist in precision selection, movement, orientation, connection, or resizing of a graphical object, which may be presented on a graphical user interface (GUI) canvas. A system or method may, for example, facilitate precision selection of a graphical object's (e.g., a line's) end point or placement of such end point on top of another object's (e.g., a square's) anchor or attachment point. Such a system or method can be beneficial with a touch screen display, where using one or more fingertips to access a graphical object on the display screen display can obstruct a user's view of the graphical object. This can result in the user performing less than accurate selecting, positioning, orienting, connecting or resizing of the graphical object, or make such actions difficult.

A system or method may assist in selecting, moving, orienting, connecting or resizing a graphical object by providing on a touch screen display an augmented view of the touch screen display directly under a user's fingertip. An embodiment may present a view window (or view port) positioned above the user's fingertip. Additionally, the view within the view window may be set to higher magnification, may be the same view size, or may be a reduced view of the area, presented on the touch screen display, below and around the user's fingertip. This may permit the user to see what lies just below a user's fingertip, which in turn can permit the user to accurately select, move, orient, connect, or resize graphical objects. Additionally, this may permit the user to perform an operation with respect to graphical content presented within the view window, moving a selected element or completing a task, such as connecting elements or objects.

For some embodiments, system or methods described herein are implemented with a digital whiteboard system, such as one similar to those described in U.S. Patent Application Publication No. 2011/0246875 and U.S. Patent Application Publication No. 2013/0111380, which are hereby incorporated by reference herein. On graphical user interface (GUI) canvas, a user may connect a line and elbow connectors to various shapes like rectangle and circles. The user may select an end point of a line or elbow connector and drag it toward a graphical object, such as a circle or square. As the user's fingertip approaches the graphical object, the view window may automatically become visible and the user can readily view the end point of the line connector as they control the end point to the graphical object by dragging their finger. As the user's finger moves closer to the graphical object the graphical object's potential connection, or anchor, points become visible (e.g., are enabled). Through the view window, the user can see the relative gap between the end point and the graphical object's anchor point and can easily maneuver the end point on top of the graphical object's anchor point to accurately connect the two. For some embodiments, when the end point reaches a certain distance from the graphical object's anchor point, the end point snaps to the anchor point to form a connection between the line and the graphical object.

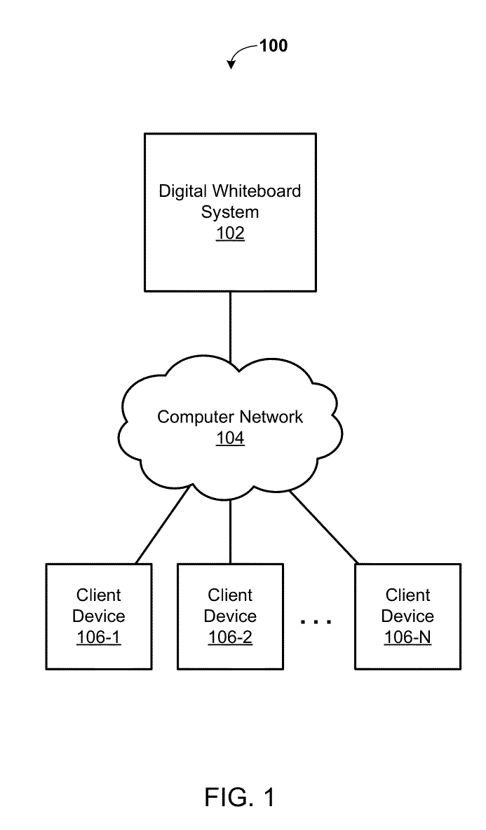

FIG. 1 is a block diagram illustrating an example environment 100 in which various embodiments can be implemented. As shown in FIG. 1, the example environment 100 can comprise a digital whiteboard system 102, client devices 106-1 through 106-N (hereafter collectively referred to as “client devices 106”), and a computer network 104 communicatively coupling together the digital whiteboard system 102 and each of the client devices 106. It will be understood that for some embodiments, the components or the arrangement of components may differ from what is depicted in FIG. 1. In accordance with some embodiments, the computer network 104 may be implemented or facilitated using one or more local or wide-area communications networks, such as the Internet, WiFi networks, WiMax networks, private networks, public networks, and the like. Depending on the embodiment, some or all of the communication connections with the computer network 104 may utilize encryption (e.g., Secure Sockets Layer [SSL]) to secure information being transferred between the various entities shown in the example environment 100.

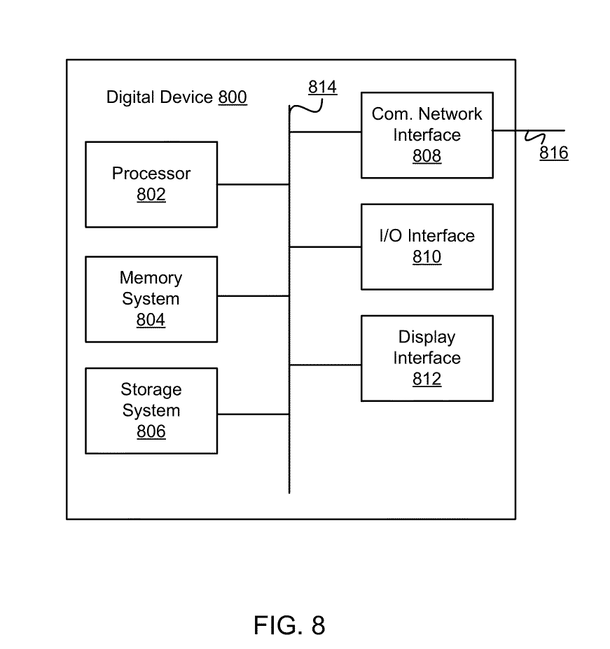

The digital whiteboard system 102 and each of the client devices 106 may be implemented using one or more digital devices, which may be similar to the digital devices discussed later with respect to FIG. 8. For instance, the client device 106-1 may be any form of computing device capable of executing an application, presenting a graphical user interface (GUI) canvas through a display (e.g., a touch screen display) coupled to the computing device, presenting on the GUI canvas one or more graphical objects that can be placed, moved, oriented, resized, or connected, presenting a view window over the GUI canvas to assist a user with selecting, placing, moving, orienting, resizing, or connecting a graphical object on the GUI canvas. The GUI canvas and changes made to the GUI canvas may be communicated over the computer network 104 to the digital whiteboard system 102, which can facilitate shared access of the GUI canvas (e.g., as a digital whiteboard) by one or more of the other client devices 106.

For instance, through the computer network 104, the client device 106-1 can provide and receive updates to a GUI canvas presented on a touch screen display coupled to the client device 106-1. Through systems or methods described herein, a user may select, move, orient, resize, or connect graphical objects on a GUI canvas, and such actions at the client device 106-1 can cause updates to be sent to the digital whiteboard system 102. Other client devices 106 that have shared access to the GUI canvas may receive updates via the digital whiteboard system 102 or directly from the client device 106-1. For some embodiments, the GUI canvas constitutes a digital whiteboard on which one or more user may add, remove, and modify (e.g., select, move, orient, connect, resize, etc.) graphical objects, including texts, shapes, images, and the like. The GUI canvas presented through the client devices 106 may be configured to provide users with (or provide the user with the experience of) an infinitely-sized work space.

Computing devices may include a mobile phone, a tablet computing device, a laptop, a desktop computer, personal digital assistant, a portable gaming unit, a wired gaming unit, a thin client, a set-top box, a portable multi-media player, or any other type of touch-enabled computing device known to those of skill in the art. Further, the digital whiteboard system 102 may comprise one or more servers, which may be operating on or implemented using one or more cloud-based services (e.g., System-as-a-Service [SaaS], Platform-as-a-Service [PaaS], or Infrastructure-as-a-Service [IaaS]).

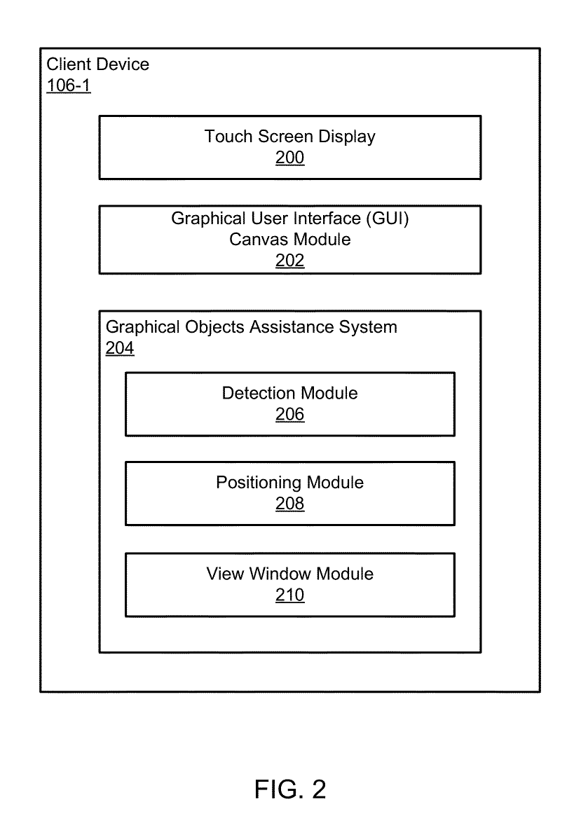

FIG. 2 is a block diagram illustrating the client device 106-1 in accordance with various embodiments. As shown in FIG. 2, the client device 106-1 can comprise a touch screen display 200, a graphical user interface (GUI) canvas module 202, and a graphical object assistance system 204. It will be understood that for some embodiments, the components or the arrangement of components may differ from what is depicted in FIG. 2.

The touch screen display 200 can represent any touch-sensitive display device that can receive user input by way of human contact (e.g., hand, fingers, fingertips, etc.) and convey said user input to a computing device to which the touch-sensitive display device is coupled. Depending on the client device 106-1, the touch screen display 200 may be a separate device from the client device 106-1 and coupled to the client device 106-1 through a data interface. For client devices, such tablets, smartphones, and touch-enabled laptops, the touch screen display 200 may be one integrated into the device. Where the client device 106-1 interfaces with a digital white board system, such as the one shown in FIG. 1, the touch screen display 200 may be one large enough to be function in place of a traditional whiteboard (e.g., in a conference room), or one may be one integrated into a mobile device (e.g., smartphone or tablet), thereby allowing multiple participants to shared access to a GUI canvas constituting a digital whiteboard.

The GUI canvas module 202 may be configured to provide or otherwise facilitate presentation of a GUI canvas at the client device 106-1 through the touch screen display 200. The GUI canvas module 202 may be further configured to update graphical content on the GUI canvas based on user input received through the touch screen display 200 or any other human interface device (HID) coupled to the client device 106-1. The GUI canvas module 202 may further update the GUI canvas based on information received from other client devices 106 that have access to the same GUI canvas (e.g., via the digital whiteboard system 102).

According to some embodiment, the graphical object assistance system 204 is configured to augment or otherwise modify the GUI canvas provided by the GUI canvas module 202 (e.g., via an application software interface) such that the GUI canvas presents graphical tools that assist a user with placement, selection, orientation, connection, resizing, or some other operation with respect to one or more graphical objects (e.g., text boxes, shapes, images, lines, etc.) presented on the GUI canvas. For some embodiments, the graphical object assistance system 204 may augment or otherwise modify the GUI canvas to provide a view window on the GUI canvas, where the view window may be configured to provide a real-time view of graphical content currently being presented under a user's fingertip on the touch screen display 200. As also shown in FIG. 2, the graphical object assistance system 204 may be implemented by a detection module 206, a positioning module 208, and a view window module 210. As noted herein, it will be understood that for some embodiments, the components or the arrangement of components of the graphical object assistance system 204 may differ from what is shown in FIG. 2.

The detection module 206 may be configured to detect a first condition for invoking (e.g., presenting) a view window on the GUI canvas presented on the touch screen display 200 by the GUI canvas module 202. The detection module 206 may be further configured to detect movement of a fingertip across the touch screen display 200 as a user access the GUI canvas and the graphical objects presented thereon. For instance, the detection module 206 may be configured to detect a user's fingertip moving from a first position to a second position on the touch screen display 200 as the user drags a graphical object on the GUI canvas. Depending on the embodiment, the detection module 206 may be also configured to a second condition for removing (e.g., hiding or moving off screen) the view window currently presented on the GUI canvas on the touch screen display 200.

The positioning module 208 may be configured to determine a position of a fingertip on the touch screen display 200 based on the first condition. For instance, in response to the first condition being met, the positioning module 208 may determine the first position of the fingertip while the fingertip is in contact with the touch screen display 200. For some embodiments, the positioning module 208 may be configured to determine the positioning of a view window when the view window is presented on the GUI canvas on the touch screen display 200. For example, where the positioning module 208 determines that the fingertip is at a first position on the touch screen display 200 when the first condition is met, the positioning module 208 may determine a second position on the touch screen display 200, relative to the first position on the touch screen display 200, to present the view window on the GUI canvas. For some embodiments, the second position is determined to be within a predetermined distance from the first position. Additionally, for some embodiments, the second position is determined according to the first position's proximity to the edge of the visible area of the touch screen display 200.

The view window module 210 may be configured to present a view window on the touch screen display 200 at a position based on position of a fingertip on the touch screen display 200. As described herein, the view window may be configured to provide a view based on the position of the fingertip on the touch screen display 200. For instance, the view window can provide a view of the graphical content presented under or around the fingertip on the touch screen display 200 (e.g., when the fingertip is contact with the touch screen display 200). Depending on the embodiment, the view window may be presented, and may be removed, according to conditions detected by the detection module 206. Additionally, depending on the embodiment, the view provided through the view window may have a larger, similar, or smaller magnification than the actual view of the graphical contents presented under or around the fingertip on the touch screen display 200. For some embodiments, when the fingertip position moves from a first position to a second position, the detection module 206 detects such movement of the fingertip and the positioning module 208 determines the positioning of the fingertip on the touch screen display 200. In some such embodiments, the positioning module 208 can determine positioning of the view window according to the positioning of the fingertip (thereby permitting the view window to follow the fingertip), and the view window module 210 can provide an updated view that reflects the graphical content currently presented on the touch screen display 200 under or around the fingertip at the second position.

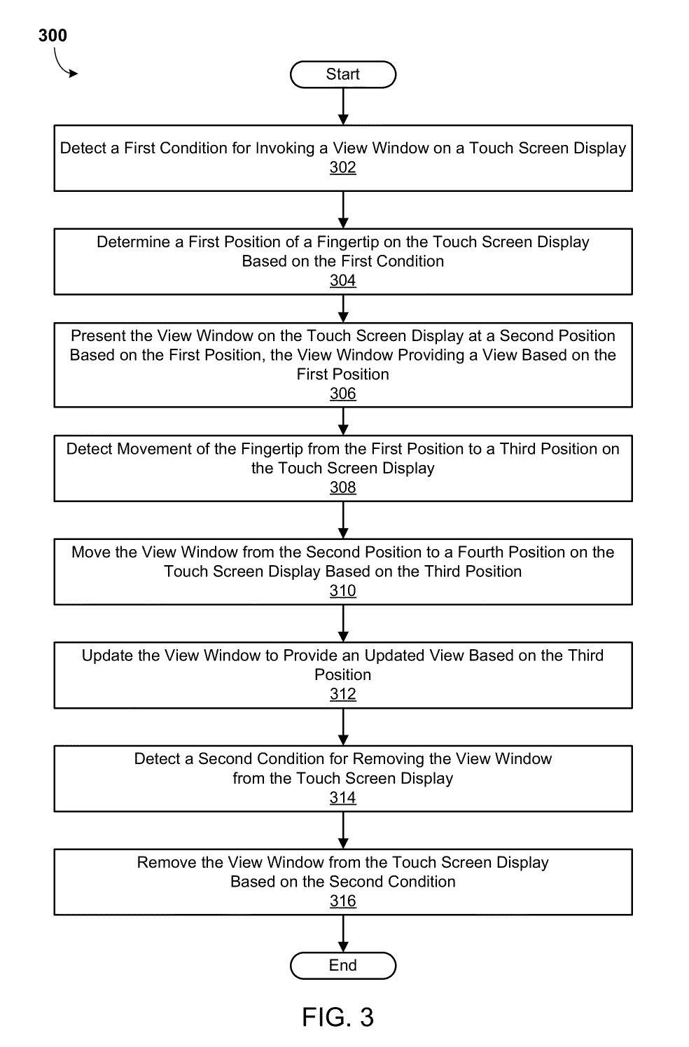

FIG. 3 is a flowchart illustrating an example method 300 for assisting with graphical objects in accordance with various embodiments. As described below, for some embodiments, the method 300 may perform operations in connection the client device 106-1.

The method 300 may start at operation 302, the detection module 206 detects a first condition for invoking (e.g., presenting) a view window on a touch screen display 200. Depending on the embodiment, the first condition may comprise a fingertip, in contact with the touch screen display 200, being positioned within a predetermined distance from a graphical object presented on the touch screen display 200. The first condition may comprise selection of a graphical object presented on the touch screen display 200, where the selection is caused by use of the fingertip on the touch screen display 200. The first condition may be limited to one or more specific types of graphical object, such as an end point of a line, an anchor point, or vertex of a shape. The first condition may relate to selecting, moving, orienting, connecting or resizing of a first graphical object presented on the touch screen display 200, where the selection, movement, orientation, or resizing may be caused by use of the fingertip on the touch screen display 200. The first condition may comprise a first graphical object presented on the touch screen display 200 being positioned within a predetermined distance from a second graphical object presented on the touch screen display 200. Additionally, the first condition may comprise receiving from a user an instruction to enable the view window (e.g., user instruction through an element of GUI).

At operation 304, the positioning module 208 determines a first position of a fingertip on the touch screen display 200 based on the first condition. For example, in response to the first condition being met, the positioning module 208 may determine the first position of the fingertip while the fingertip is in contact with the touch screen display 200.

At operation 306, the view window module 210 presents the view window on the touch screen display 200 at a second position based on the first position, where the view window provides a view based on the first position of the fingertip. For some embodiments, the view window provides a view of graphical content presented under the fingertip, on the touch screen display 200, while the fingertip is at the first position.

At operation 308, the detection module 206 detects movement of the fingertip from the first position to a third position on the touch screen display 200. At operation 310, the view window module 210 moves the view window from the second position to a fourth position on the touch screen display 200 based on the third position. Additionally, at operation 312, the view window module 210 updates the view window to provide an updated view based on the third position. In this way, as the view window moves from the second position to the fourth position, the view provided by the view window can be updated dynamically and may be updated in real-time (e.g., as movement of the fingertip occurs).

At operation 314, the detection module 206 detects a second condition for removing the view window from the touch screen display 200. Depending on the embodiment, the second condition may comprise the fingertip, in contact with the touch screen display 200, being positioned outside a predetermined distance from a graphical object presented on the touch screen display 200. The second condition may comprise de-selection of a graphical object presented on the touch screen display 200 and currently selected. The second condition may comprise the user lifting their finger from touch surface of the touch screen display 200, thereby remove contact between the fingertip and the touch screen display 200. The second condition may comprise a first graphical object presented on the touch screen display 200 being positioned outside a predetermined distance from a second graphical object presented on the touch screen display 200. Additionally, the second condition comprises receiving from a user an instruction to disable the view window (e.g., user instruction through an element of GUI).

At operation 316, the view window module 210 removes (e.g., from visibility) the view window from the touch screen display 200 based on the second condition (e.g., in response to the second condition). Depending on the embodiment, removing the view window from the touch screen display 200 may comprise moving the view window off screen, hiding the visibility of the view window, or the like.

Though the operations of the above method may be depicted and described in a certain order, those skilled in the art will appreciate that the order in which the operations are performed may vary between embodiments, including performing certain operations in parallel. Additionally, those skilled in the art will appreciate that the components described above with respect to the method 300 of the flowchart are merely examples of components that may be used with the method, and for some embodiments other components may also be utilized in some embodiments.

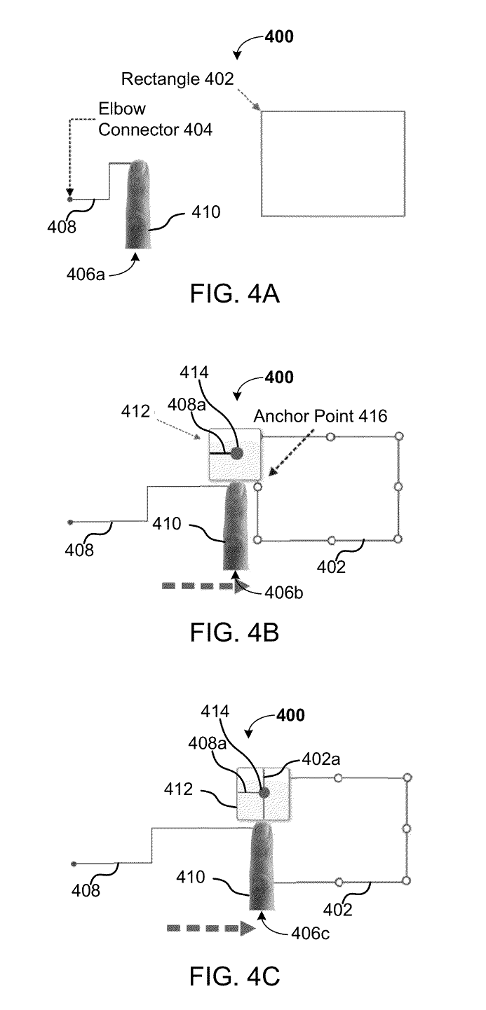

FIGS. 4A-4C illustrate an example graphical user interface (GUI) canvas 400 using graphical object assistance in accordance with various embodiments. In particular, FIGS. 4A-4C illustrate a method for placing a graphical object and connecting the graphical object to another graphical object on touch-enabled computing devices according to some embodiments. For some embodiments, systems and methods provide a view window to assist with moving a selected graphical object, such as an end point of a line, to an attachment or anchor point of another graphical object, such as a rectangle, thereby facilitating a connection between the two graphical objects.

FIG. 4A depicts the GUI canvas 400 comprising multiple graphical objects, including a rectangle 402 and a line 408 having an elbow connector 404. The GUI canvas 400 may be presented through a touch screen display of a touch-enabled computing device. As shown in FIG. 4A, a user may use their finger 410, at a position 406a, to select an end point of the line 408. According to some embodiments, a user can user their finger 410 to tap on the end point of the line 408 and drag the end point to an anchor or attachment point on another graphical object, such as the rectangle 402.

In FIG. 4B, the GUI canvas 400 illustrates how a view window 412 is presented to assist a user in moving the end point of the line 408, and may assist in moving the end point of the line 408 to the rectangle 402. As shown in FIG. 4B, the user may move their finger 410 from the position 406a to a position 406b and may do so by dragging the end point of the line 408 using their finger 410. According to some embodiments, the view window may be presented (e.g., invoked) when the end point of the line 408 is dragged toward the rectangle 402 by the user's finger 410 and when the end point of the line 408 moves within a predetermined distance (e.g., sufficient proximity) to the rectangle 402 or one of its anchor points, such as an anchor point 416. Those skilled in the art will appreciate that for some embodiment similar or alternative conditions may be used to invoke the view window to assist a user with graphical objects. Additionally, for some embodiments, the conditions are, at least in part, determined according to hardware or software settings (e.g., user preferences or default settings) implemented in those embodiments. Additionally, for some embodiments, the conditions are, at least in part, determined according to hardware or software settings (e.g., user preferences or default settings) implemented in those embodiments. For example, a user may enable or disable the conditions under which the view window 412 should appear or disappear, or the user may define a predetermined distance for automatically invoking the view window 412.

As also shown in FIG. 4B, the view window 412 may provide a view of a portion 408a of the line 408 as it appears (on the touch screen display) under or around the tip of the user's finger 410, and may also provide a view of the end point 414 of the line 408. Depending on the embodiment, the view window 412 may track or follow the user's finger 410 as it moves across the GUI canvas 400. Additionally, for some embodiments, the view window 412 provides a magnified view of the graphical content presented under the tip of the user's finger 410.

In FIG. 4C, the GUI canvas 400 illustrates how the user can drag the end point of the line 408 to the anchor point the rectangle 402, how the view window 412 can synchronously move with the user's finger 410, and how the view window 412 can update its view according to the user's finger 410 at a position 406c. Based on the update, the view window 412 can provide a view of the portion 408a of the line 408, the end point 414 of the line 408, and a portion 402a of the rectangle 402. As described herein, when the end point 414 reaches a certain distance from the anchor point 416, or the like, the end point 414 may snap to the anchor point 416 to form a connection between the line 408 and the rectangle 402.

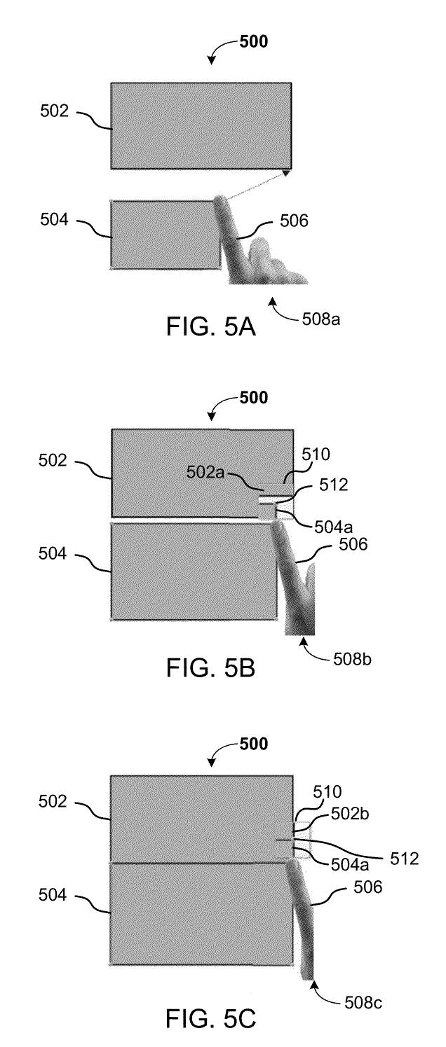

FIGS. 5A-5C illustrate an example graphical user interface (GUI) canvas 500 using graphical object assistance in accordance with various embodiments. In particular, FIGS. 5A-5C illustrate a method for precision resizing of graphical objects on touch-enabled computing devices according to some embodiments. For some embodiments, the systems and methods provide a view window that assists the user in moving a vertex of a shape, which in turn can facilitate the resizing of the shape.

FIG. 5A depicts the GUI canvas 500 comprising multiple graphical objects, including rectangle 502 and 504. The GUI canvas 500 may be presented through a touch screen display of a touch-enabled computing device. As shown in FIG. 5A, a user may use their finger 506, at a position 508a, to select a vertex of the rectangle 504 and drag the vertex to resize the rectangle 504. As shown in FIG. 5A, resizing the rectangle 504 in this manner can bring the rectangle 504 closer to the rectangle 502 and possibly bring the rectangle 504 with the rectangle 502. According to some embodiments, a user taps a vertex of the rectangle 504 and then drags the vertex.

In FIG. 5B, the GUI canvas 500 illustrates how a view window 510 is presented to assist a user in moving the vertex of the rectangle 504 and, in doing so, resizing the rectangle 504. FIG. 5B illustrates the user moving their finger 506 from the position 508a to a position 508b and may do so by dragging the vertex of the rectangle 504 using their finger 506. For some embodiments, the view window may be presented (e.g., invoked) when the vertex of the rectangle 504 is dragged toward the rectangle 502 by the user's finger 506 and when the vertex of the rectangle 504 moves within a predetermined distance (e.g., sufficient proximity) to the rectangle 502 or one of its anchor points. Those skilled in the art will appreciate that for some embodiment similar or alternative conditions may be used to invoke the view window to assist a user with graphical objects. Additionally, for some embodiments, the conditions are, at least in part, determined according to hardware or software settings (e.g., user preferences or default settings) implemented in those embodiments. For example, a user may enable or disable the conditions under which the view window 510 should appear or disappear, or the user may define a predetermined distance for automatically invoking the view window 510.

As also shown in FIG. 5B, the view window 510 may provide a view of a portion of 502a of the rectangle 502, a portion 504a of the rectangle 504, and the vertex 512 of the rectangle 504 as they appear (on the touch screen display) under or around the tip of the user's finger 506. Depending on the embodiment, the view window 510 may track or follow the user's finger 506 as it moves across the GUI canvas 500. Additionally, for some embodiments, the view window 510 provides a magnified view of the graphical content presented under the tip of the user's finger 506.

In FIG. 5C, the GUI canvas 500 illustrates how the user can drag the vertex of the rectangle 504 toward the rectangle 502, how the view window 510 can synchronously move with the user's finger 506, and how the view window 510 can update its view according to the user's finger 506 at a position 508c. Based on the update, the view window 510 can provide a view of the portion 502b of the rectangle 502, the portion 504a of the rectangle 504, and the vertex 512 of the rectangle 504. Because the view window 510 provides a view of both the rectangle 502 and the rectangle 504 that is otherwise covered by the tip of the user's finger 506, the user can use the view window 510 to accurate move the vertex 512 of the rectangle 504 and resize the rectangle 504 such that rectangle 504 aligns with the rectangle 502.

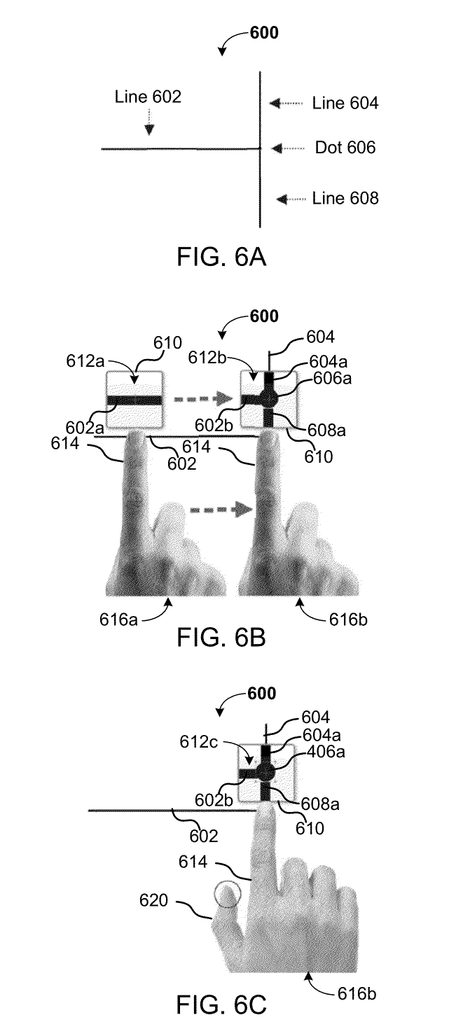

FIGS. 6A-6C illustrate an example graphical user interface (GUI) canvas 600 using graphical object assistance in accordance with various embodiments. In particular, FIGS. 6A-6C illustrate a method for precision selection of graphical objects on touch-enabled computing devices according to some embodiments. For some embodiments, systems and methods assist with selection of a graphical object that may otherwise be a difficult to select due to the graphical object's size, due to the graphical object's proximity to one or more graphical objects, or due to a user's finger obscuring the view of a graphical object on a display of a touch-enabled computing device (hereafter, “touch screen display”). Various embodiments assist in selection of graphical object to invoke a view window that enables a user to see and select an object, which may otherwise be obscured or difficult to see with the accuracy desired by a user to perform selection or placement of the graphical object. In some embodiments, the view window provides a crosshair or some other visual indicator that facilitates accurate selection of graphical objects on a display device, such as a touch screen display. The view window may be configured such that the provided crosshair (or other visual indicator) emulates a cursor and can be utilized on a touch screen display in methods similar to those employed by a mouse and cursor on a computing device. For instance, a user may enable (e.g., invoke) the view window on a touch screen display, and the view window may function as a viewer and precious selection aid while the user uses their finger on the touch-enabled surface (of the touch screen display) to select and drag a graphical object displayed on the touch screen display.

FIG. 6A depicts the GUI canvas 600 comprising multiple graphical objects, including lines 602, 604, and 608, and a dot 606. The GUI canvas 600 may be presented through a touch screen display of a touch-enabled computing device. In FIG. 6B, the GUI canvas 600 illustrates presentation of a view window 610 with a crosshair that can assist a user in selecting a desired graphical object using the user's finger 614 on a touch screen display. For some embodiments, views 612a and 612b provided by the view window 610 include the crosshair 612 functions as a virtual cursor that can assist a user in precision selection of a desired object. Additionally, for some embodiments, the views 612a and 612b presented by the view window 610 may provide a magnified view to the portion of the GUI canvas 600 currently shown on the touch screen display under (and possibly around) the tip of the user's finger 614. For example, the view 612a may depict a portion 602a of the line 602 as it is shown under and around the tip of the user's finger 614 while the user's finger 614 is at a position 616a on the GUI canvas 600. Similarly, the view 612b may depict a portion 602b of the line 602, a portion 606a of dot 606 (hereafter referred to as the “dot 606a”), a portion 604a of the line 604, and a portion 608a of the line 608 as they appear on the GUI canvas 600 under and around the tip of the user's finger 614 while the user's finger 614 is at a position 616b on the GUI canvas 600. For some embodiments, the view window 610 also tracks the movement of tip of the user's finger 614 and changes the view of presented by the view window 610 accordingly. For example, while maintaining contact with the touch screen display, the user may drag their finger from the position 616a to the position 616b, which may cause a corresponding change (from the view 612a to the view 612b) in the view window 610, thereby reflecting the change in position of the tip of the user's finger 614.

In FIG. 6C, the GUI canvas 600 illustrates the user selecting a graphical object using the crosshairs. In some embodiments, once the user has the desired graphical object identified in the crosshairs, the user taps on the touch screen display using the user's finger 614 or another user finger while the user's finger 614 remains in contact with the touch screen display. For example, as shown in FIG. 6C, the user may identify in the view window 610 the dot 606a in the crosshairs and the user may select the dot 606a by tapping the touch screen display using their thumb 620. For some embodiments, the tapping on the screen with the thumb 620 or other finger is similar to a left mouse click on a personal computing (PC) system, which can facilitate the selection of a graphical object below a mouse cursor. For some embodiments, a second tap on the screen using the same finger, or a different finger, can deactivate selection of the graphical object.

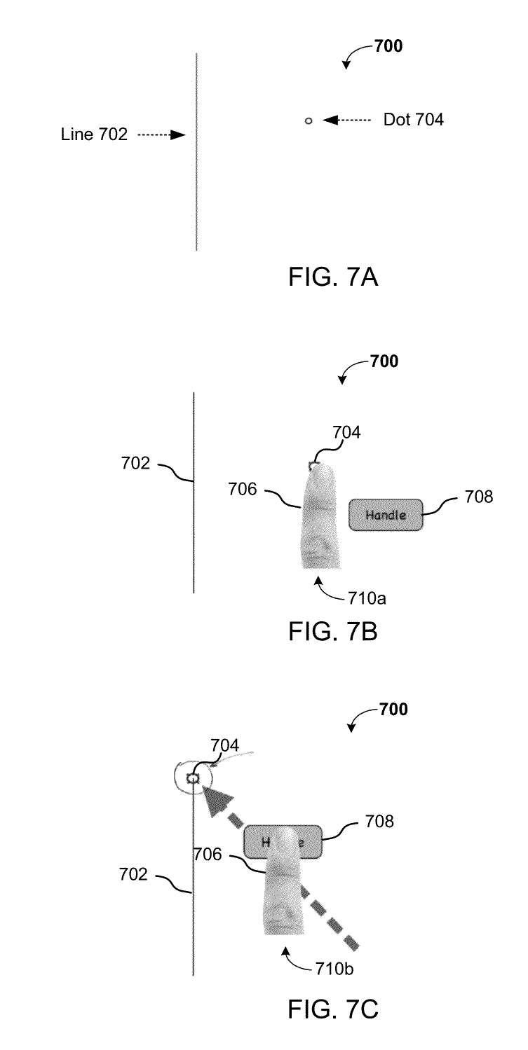

FIGS. 7A-7C illustrate an example graphical user interface (GUI) canvas 700 using graphical object assistance in accordance with various embodiments. In particular, FIGS. 7A-7C illustrate a method for precision movement of graphical objects on touch-enabled computing devices according to some embodiments. For some embodiments, systems and methods assist with placement or selection of a graphical object that may otherwise be a difficult to position (e.g., on a GUI canvas) due to the graphical object's size, due to the graphical object's proximity to one or more graphical objects, or due to a user's finger obscuring the view of a graphical object on a touch screen display. Certain embodiments may permit a user in creating a small graphical object, such as a circle representing a dot, and moving the resulting graphical object while preventing such action from being interpreted as a resizing of the graphical object when that is not what the user intends.

In some embodiments, a graphical element is provided that functions as a handle for a graphical object (hereafter, a “graphical object handle”). The graphical object handle may appear on a display device, such as a touch screen display, near or adjacent to a graphical object with which it is associated. For instance, the graphical object handle may be positioned offset from the associated graphical object, and may maintain such positioning relative to the associated graphical object when the graphical object handle is used to move the associated graphical.

For some embodiments, a graphical object handle associated with a graphical object appears once the graphical object has been selected by the user. Once the user has selected the object, the graphical object handle may appear on the display device as a new (yet temporary) graphical element. The graphical object handle may be associated to the graphical object such that the graphical object handle is effectively connected to the associated graphical object. This effective connection may exist even when the graphical object handle appears offset from the associated graphical object and even when no graphical representation of the connection is presented on the display device. By way of the association between a graphical object handle and a graphical object, when a user selects and moves the graphical object handle, the associated graphical object may move as well and may move such that the relative positioning between the graphical object handle and the associated graphical object (as shown on the display device) is maintained. In this way, the movement of a graphical object may be synchronized with a graphical object handle that is associated with the graphical object. For example, moving a graphical object handle 1 inch to the right may cause its associated graphical object to correspondingly move to the right 1 inch. This can apply to all directions of motion and may appear to the user as if there is an invisible connection between the graphical object handle and the graphical object to which it is associated. As noted above, providing such a graphical object handle can assist in the precision movement of graphical objects that may otherwise be too small or too close to other graphical objects to move, particularly by way of a touch screen display using a user's finger. Providing such a graphical object handle can also assist in those situations where a user intends for their user input to be interpreted as an action to move a graphical object, rather than it being mistakenly interpreted as an action to resize the graphical object.

In some embodiments, graphical object handles are provided for use with graphical objects on a graphical user interface (GUI) canvas, such as one utilized by a digital whiteboard application operating in association with one or more computing device. The digital whiteboard application may be one configured to provide collaborative access to a digital whiteboard by two or more computing devices. Users of the GUI canvas may create on the digital whiteboard a small graphical object, such as a small circle representing a dot or a point. When the user selects the small circle on GUI canvas, the GUI canvas may display a bounding box, resize points, or both, in association with the small circle, that permit a user to resize the small circle. Additionally, when the user selects the small circle on GUI canvas, the GUI canvas may display a graphical object handle associated with the small circle and that permits the user to move the small circle on the GUI canvas with precision. The graphical object handle may be distinct and separate from the graphical elements that facilitate resizing of the small circle. Accordingly, instead of selecting and attempting to move the dot directly, which may be in accurately interpreted as a resize action (given the small size of the circle), the user can select and move the graphical object handle to accurately position the small circle on the GUI canvas in relation to other graphical objects on the GUI canvas.

FIG. 7A depicts the GUI canvas 700 comprising multiple graphical objects, including a line 702 and a dot 704. The GUI canvas 700 may be presented through a touch screen display of a touch-enabled computing device. As described herein, the dot 704 may be formed by a user creating a small circle on the GUI canvas 700. In FIG. 7B, the GUI canvas 700 illustrates a user selecting the dot 704 using their finger 706. The user may select the dot 704 by way of tapping their finger 706 on the dot 704, or by some other form of interaction with the GUI. For some embodiments, when the user selects the dot 704, a graphical object handle 708 is active and presented on the GUI canvas 700. Depending on the embodiment, the graphical object handle 708 may appear as shown in FIG. 7B, or may have an alternative appearance (e.g., shape, labeling or no labeling, etc.). Additionally, the positioning of the graphical object handle 708 relative to the dot 704 may differ between embodiments. For example, initial position of the graphical object handle 708 relative to the dot 704 may be based on user settings (e.g., position the graphical object handle a predetermined distance from the dot 704) or current positioning of the dot 704 on the GUI canvas 700 (e.g., based on the dot 704's proximity to the border of the display device). For some embodiments, once the graphical object handle 708 appears, the relative positioning between the graphical object handle 708 and the dot 704 is static and remains as such when the user moves the graphical object handle 708, thereby causing a corresponding movement to the dot 704. For instance, after the user has selected the graphical object handle 708 and while maintaining contact with the touch screen display, the user may drag their finger from the position 710a, as shown in FIG. 7B, to a position 710b, as shown in FIG. 7C. As illustrated in FIG. 7C, the user's movement of the graphical object handle 708 can result in a corresponding movement of the dot 704. In FIG. 7C, the user uses the graphical object handle 708 to position the dot 704 to the end of the line 702.

FIG. 8 is a block diagram of an exemplary digital device 800. The digital device 800 comprises a processor 802, a memory system 804, a storage system 806, a communication network interface 808, an I/O interface 810, and a display interface 812 communicatively coupled to a bus 814. The processor 802 is configured to execute executable instructions (e.g., programs). In some embodiments, the processor 802 comprises circuitry or any processor capable of processing the executable instructions.

The memory system 804 is any memory configured to store data. Some examples of the memory system 804 are storage devices, such as RAM or ROM. The memory system 804 can comprise the RAM cache. In various embodiments, data is stored within the memory system 804. The data within the memory system 804 may be cleared or ultimately transferred to the storage system 806.

The storage system 806 is any storage configured to retrieve and store data. Some examples of the storage system 806 are flash drives, hard drives, optical drives, and/or magnetic tape. In some embodiments, the digital device 800 includes a memory system 804 in the form of RAM and a storage system 806 in the form of flash data. Both the memory system 804 and the storage system 806 comprise computer readable media which may store instructions or programs that are executable by a computer processor including the processor 802.

The communications network interface (com. network interface) 808 can be coupled to a network (e.g., the computer network 104) via the link 816. The communication network interface 808 may support communication over an Ethernet connection, a serial connection, a parallel connection, or an ATA connection, for example. The communication network interface 808 may also support wireless communication (e.g., 802.11a/b/g/n, WiMax). It will be apparent to those skilled in the art that the communication network interface 808 can support many wired and wireless standards.

The optional input/output (I/O) interface 810 is any device that receives input from the user and output data. The optional display interface 812 is any device that is configured to output graphics and data to a display. In one example, the display interface 812 is a graphics adapter.

It will be appreciated by those skilled in the art that the hardware elements of the digital device 800 are not limited to those depicted in FIG. 8. A digital device 800 may comprise more or less hardware elements than those depicted. Further, hardware elements may share functionality and still be within various embodiments described herein. In one example, encoding and/or decoding may be performed by the processor 802 and/or a co-processor located on a GPU (i.e., Nvidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

What is claimed is:

1. A method comprising:
detecting a first condition for presenting a view window on a touch screen display;
determining a first position of a fingertip on the touch screen display;
in response to the first condition, presenting the view window on the touch screen display at a second position based on the first position, the view window providing a first view of graphical content presented at least under the fingertip on the touch screen display at the first position;
detecting movement of the fingertip from the first position to a third position;
moving the view window from the second position to a fourth position based on the third position;
updating the view window to provide a second view of graphical content presented at least under the fingertip on the touch screen display at the third position; and
detecting a second condition for removing the view window from the touch screen display.

2. The method of claim 1, wherein the graphical content presented under the fingertip on the touch screen display at the first position comprises one or more graphical objects.

3. The method of claim 1, wherein the movement of the fingertip from the first position to the third position is associated with selecting, moving, orienting, connecting or resizing a graphical object presented on the touch screen display.

4. The method of claim 1, further comprising determining the second position based on the first position or determining the fourth position based on the third position.

5. The method of claim 1, wherein the first condition comprises the fingertip being positioned within a predetermined distance from a graphical object presented on the touch screen display.

6. The method of claim 1, wherein the first condition comprises selection of a graphical object presented on the touch screen display, the selection being caused by use of the fingertip on the touch screen display.

7. The method of claim 1, wherein the first condition relates to selecting, moving, orienting, connecting or resizing a first graphical object presented on the touch screen display, the movement, orienting, connecting or resizing being caused by use of the fingertip on the touch screen display.

8. The method of claim 1, wherein the first condition comprises a first graphical object presented on the touch screen display being positioned within a predetermined distance from a second graphical object presented on the touch screen display.

9. The method of claim 1, wherein the first condition comprises receiving from a user a first instruction to enable the view window, or the second condition comprises receiving from the user a second instruction to enable the view window.

10. The method of claim 1, wherein the second condition comprises the fingertip being positioned outside a predetermined distance from a graphical object presented on the touch screen display.

11. The method of claim 1, wherein the second condition comprises de-selection of a graphical object presented on the touch screen display.

12. The method of claim 1, wherein the second condition comprises removal of contact between the fingertip and the touch screen display.

13. The method of claim 1, wherein the second condition comprises a first graphical object presented on the touch screen display being positioned outside a predetermined distance from a second graphical object presented on the touch screen display.

14. The method of claim 1, wherein the first view is a first magnified view of graphical content presented under the fingertip on the touch screen display at the first position, or the second view is a second magnified view of graphical content presented under the fingertip on the touch screen display at the third position.

15. A system comprising:
means for detecting a first condition for presenting a view window on a touch screen display;
means for determining a first position of a fingertip on the touch screen display;
means for presenting the view window on the touch screen display at a second position based on the first position, the view window providing a first view of graphical content presented at least under the fingertip on the touch screen display at the first position;
means for detecting movement of the fingertip from the first position to a third position;
means for moving the view window from the second position to a fourth position based on the third position;
means for updating the view window to provide a second view of graphical content presented at least under the fingertip on the touch screen display at the third position; and
means for detecting a second condition for removing the view window from the touch screen display.

16. A system comprising:
a touch screen display;
a detection module configured to detect a first condition for presenting a view window on the touch screen display, detect a second condition for removing the view window from the touch screen display, and detect movement of the fingertip on the touch screen display;
a positioning module configured to determine positioning of a fingertip on the touch screen display; and
a view window module configured to present the view window on the touch screen display at a first position based on a second position of the fingertip on the touch screen display, and move the view window on the touch screen display from the first position to a third position based on a fourth position of the fingertip when the fingertip moves from the second position to the fourth position, the view window providing a first view of graphical content presented at least under the fingertip on the touch screen display at the second position, and the view window providing a second view of graphical content presented at least under the fingertip on the touch screen display at the fourth position.

17. The system of claim 16, wherein the graphical content presented on the touch screen comprises one or more graphical objects.

18. The system of claim 16, wherein the movement of the fingertip from the first position to the third position is associated with moving, orienting, connecting or resizing a graphical object presented on the touch screen display.

19. The system of claim 16, the positioning module is further configured to determine the first position based on the second position or determining the third position based on the fourth position.

20. The system of claim 16, wherein the first condition comprises the fingertip being positioned within a predetermined distance from a graphical object presented on the touch screen display.

21. The system of claim 16, wherein the first condition comprises selection of a graphical object presented on the touch screen display, the selection being caused by use of the fingertip on the touch screen display.

22. The system of claim 16, wherein the first condition relates to selecting, moving, orienting, connecting or resizing a first graphical object presented on the touch screen display, the movement, orienting, connecting or resizing being caused by use of the fingertip on the touch screen display.

23. The system of claim 16, wherein the first condition comprises a first graphical object presented on the touch screen display being positioned within a predetermined distance from a second graphical object presented on the touch screen display.

24. The system of claim 16, wherein the first condition comprises receiving from a user a first instruction to enable the view window, or the second condition comprises receiving from the user a second instruction to enable the view window.

25. The system of claim 16, wherein the second condition comprises the fingertip being positioned outside a predetermined distance from a graphical object presented on the touch screen display.

26. The system of claim 16, wherein the second condition comprises de-selection of a graphical object presented on the touch screen display.

27. The system of claim 16, wherein the second condition comprises removal of contact between the fingertip and the touch screen display.

28. The system of claim 16, wherein the second condition comprises a first graphical object presented on the touch screen display being positioned outside a predetermined distance from a second graphical object presented on the touch screen display.

29. The system of claim 16, wherein the first view is a first magnified view of graphical content presented under the fingertip on the touch screen display at the second position, or the second view is a second magnified view of graphical content presented under the fingertip on the touch screen display at the fourth position.
